(19) United States
(12) Patent Application Publication
(10) Pub. No.: US 2002/0093287 A1
(43) Pub. Date: Jul. 18, 2002

(54) White light LED

(76) Inventor: Hsing Chen, Hsin Chu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/965,839

(22) Filed: Oct. 1, 2001

(30) Foreign Application Priority Data
Jan. 17, 2001 (TW) 090201240

(51) Int. Cl. H01J 1/62

(52) U.S. Cl. 313/512

(57) ABSTRACT

For traditional “white light LED”, the emitted white light comes from the mutual compensation of blue light and yellow light when blue light LED chip surface is coated with a yellow fluorescent powder layer. Since the fluorescent powder is not evenly distributed on the surface and peripheries of blue light LED chip, the emitted “white” light is not uniform in color, but a little more blue color appearing at the core portion and a little more yellow color appearing at peripheral portion. As a result, the light viewed as white light by human eyes is projected on a white paper to become bluish at center and yellowish at peripheries. The present invention of “Improvement on White Light LED” is to add an extra diffusion layer on the fluorescent powder layer and to use refraction by such a diffusion layer containing transparent microparticles to enhance the evenness of light, which can solve the problem of light unevenness with white light LED (FIG. 2).

### BACKGROUND OF THE ONVENTION

1. Field of the Invention

The present invention is to provide improvement on white light LED, especially a technology of adding an extra diffusion layer on a fluorescent powder layer, which can diffuse light through refraction by transparent microparticles in the diffusion layer to give more uniform color and to solve the problem of uneven color with LED.

2. Description of the Prior Art

The present white light LED is formed with dual wavelength by adding yellow fluorescent powder on a blue light chip. The greatest disadvantage of this method is uneven color, which is because of two reasons. One is that a little more addition of yellow fluorescent powder can cause the color a little yellowish while a little less addition of yellow fluorescent powder can cause the color a little bluish. The other reason is that because LED chip is as small (about 350 μm×350 μm) as sand, when it is placed in the concave cup of LED support, the light emitted from the concave cup becomes uneven, so that the light emitted from the core of LED chip is brighter while the light reflected from the peripheries is darker. It is the same for Lamp type LED that the emitted white light is not uniform no matter how good the technology of adding fluorescent powder to blue light LED is. Usually, the core portion is a little more bluish and the peripheral portion is a little more yellowish. This is why people are criticizing the uneven color for the white light resulted by adding fluorescent powder to blue light chip. If the evenness of light can not be controlled, how can the “white light LED” be called “the lighting source of the 21^{st} century”?

The inventor has many years of experience in white light LED production and obtained several domestic and foreign patents with a success in commercialization of this product, which has comparable quality to Japanese products. Recently, the inventor is very dedicated to solving the problem of uneven color with white light LED and finds the solution that can provide uniform color to various applications in lighting sources and signal lights for the future.

### SUMMARY OF THE INVENTION

The skill adopted in the present invention is to add an extra diffusion layer onto the yellow fluorescent powder layer (YAG etc.) on the blue light LED chip placed in LED support or concave cup. Through the diffusion layer, light is diffused and refracted to become more uniform. The diffusion layer is made of a mixture of tiny transparent globules and transparent gel, which makes emitted light even by refraction. Another skill is to add a little white TiO₂ powder in the diffusion layer to make light even. Nevertheless, if the addition is too much, the brightness will decrease even the color becomes more uniform. Hence, adequate addition of diffusion layer is necessary. Proper adjustment should be made according to customer needs. For example, the traffic lights (white light) for pedestrians in United States do not require evenness of color, but only require white color that can be recognized by human eyes, while the lighting tools still require evenness of color.

Evenness of light is required for white light LED in the applications as lighting sources, so the present improvement is very important. Although there is an extra step in the production process, it does not cost much. Thus, the quality is improved. The improvement on products is considered as a progressive innovation, which has not been published in any literature.

### BRIEF DESCRIPTION OF THE DRAWINGS

The drawings disclose an illustrative embodiment of the invention that serves to exemplify the various advantages and objects hereof, and are as follows.

Embodiments

Figures

FIG. 1 is the structural diagram for traditional white light LED.

FIG. 2 is the structural diagram in the present invention of “Improvement on White Light LED”.

Annotation in Figures:

1: blue light chip

2: electrode support; 21: electrode

3: fluorescent powder layer

4: diffusion layer

5: packaging resin

### DETAILED DESCRIPTION OF THE PREFERRED ENBODIMENT

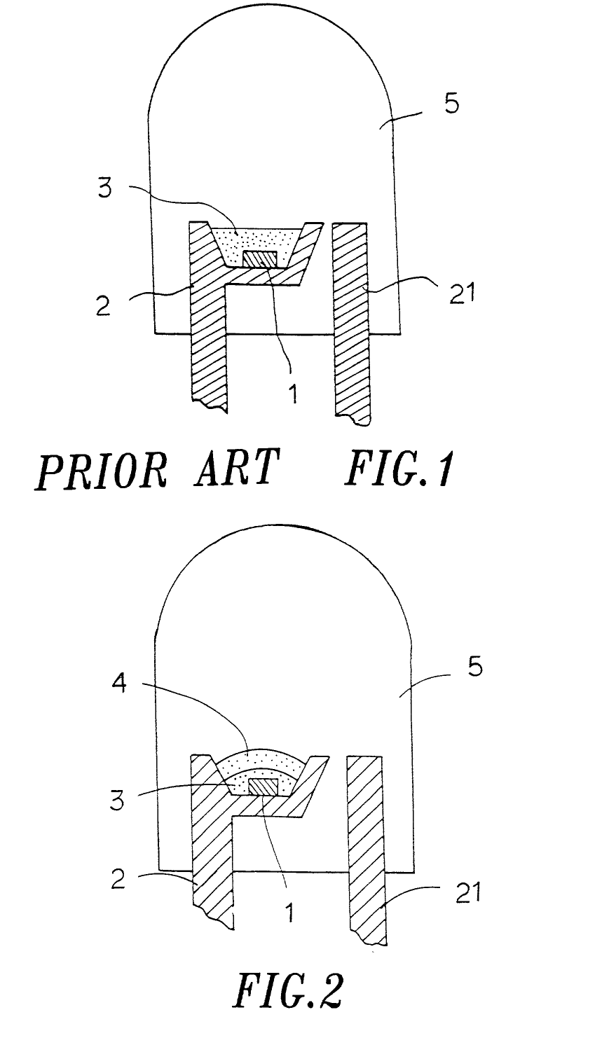

Please refer to FIG. 1 for the structural diagram for traditional white light LED. The structural diagram shows: fixing blue light LED chip 1 to electrode support 2; dispensing gel to form YAG yellow fluorescent powder layer 3; using blue light to excite the yellow fluorescent powder to generate a combination of blue light and yellow light as white light of dual wavelength. Since the white light generated according to the structural diagram in FIG. 1 is uneven (due to precipitation of YAG fluorescent powder and uneven distribution), improvement is made in the present invention of “Improvement on White Light LED” as shown in the structural diagram of FIG. 2. It is to specially add an extra diffusion layer 4 on the fluorescent powder layer 3 in the structural diagram of FIG. 1. The diffusion layer 4 contains a mixture of transparent microparticles and transparent resin or transparent gel. Through refraction by transparent microparticles, light is diffused to become more uniform. This adopts the same principle as the diffusion film in LCD back light module. The inventor applies the principle to the production of white light LED. The last step is to use packaging resin 5 to form Lamp type LED.

In diffusion layer 4, besides mixing transparent gel with transparent microparticles, a little TiO2 powder can also be added to make more uniform emitted light, but with decreased brightness. It is necessary to properly adjust the addition according to the customer's requirement of light evenness. The microparticles in the diffusion layer 4 can be glass powder SiO₂ or transparent plastic particles such as PMMA, PET, PC and PE etc. The present invention of “Improvement on White Light LED” aims at traditional process to make improvement. The unevenness of light from LED of traditional process is further confirmed by that the colors of one hundred LEDs the inventor has purchased are concluded as “all different”. This also manifests the significant difficulty in producing white light LED with uniform light. The present invention specially adds an extra “light diffusion layer” on the fluorescent layer to enhance light evenness. Although this is a simple method, it has a progressive and innovative effect, which meets the requirement of new type patent and is hereby submitted for patent application.

In addition, the samples with explanation by the inventor according to the invention are available for the committee review.

Many changes and modifications in the above-described embodiment of the invention can, of course, be carried out without departing from the scope thereof.

Accordingly, to promote the progress in science and the useful arts, the invention is disclosed and is intended to be limited only by the scope of the appended claims.

What is claimed is:

1. An improvement on white light LED, which is composed of an electrode support, LED emitting chips, a fluorescent powder layer, a diffusion layer and packaging resin, wherein the process includes placing LED emitting chips on electrode support, followed by dispensing gel material to form a fluorescent powder layer that covers LED emitting chips, finally followed by using packaging resin for encapsulation; and the process has a feature that uses the diffusion layer containing transparent microparticles makes LED emitted light more uniform through light refraction.

2. The improvement on white light LED of claim 1, wherein the material of the transparent microparticles contained in the diffusion layer is inorganic glass powder (SiO₂) or polymeric material such as PMMA, PET, PC and PET.
